(19) United States
(12) Patent Application Publication
(10) Pub. No.: US 2015/0248650 A1
(43) Pub. Date: Sep. 3, 2015

(54) MATCHING DEVICE, MATCHING METHOD, AND NON-TRANSITORY COMPUTER READABLE MEDIUM STORING PROGRAM

(71) Applicant: NEC Corporation, Tokyo (JP)

(72) Inventors: Nobutatsu Nakamura, Tokyo (JP); Yasuyuki Tomonaga, Tokyo (JP)

(73) Assignee: NEC Corporation

(21) Appl. No.: 14/630,762

(22) Filed: Feb. 25, 2015

(30) Foreign Application Priority Data
Feb. 28, 2014 (JP) 2014-039706

(51) Int. Cl. G06Q 10/10

(52) U.S. Cl. CPC G06Q 10/1053

(57) ABSTRACT

Provided are a matching device, a matching method, and a non-transitory computer readable medium storing a program, which are capable of performing matching between two pieces of information having different properties. A matching device that performs matching between a human resource that searches for an organization that meets a specific requirement and an organization that searches for a human resource that meets a specific requirement includes: a storage unit that holds human resource information indicative of a requirement for the human resource and organization information indicative of a requirement for the organization; and a matching processing unit that calculates a matching score representing a relationship between the human resource information and the organization information.

### INCORPORATION BY REFERENCE

This application is based upon and claims the benefit of priority from Japanese patent application No. 2014-039706, filed on Feb. 28, 2014, the disclosure of which is incorporated herein in its entirety by reference.

### BACKGROUND OF THE INVENTION

1. Technical Field

The present invention relates to a matching device, a matching method, and a non-transitory computer readable medium storing a program. For example, the present invention relates to a technique for performing matching between two pieces of information having different properties.

2. Background Art

In recent years, a technique for performing matching between two pieces of information has been widely used. Examples of the application of the matching technique include a job information website on the Internet. In general, information about job seekers, or those who seek a job, and information about recruiting companies, or companies that require job seekers who meet specific requirements, are registered on a job information website. A job seeker first registers resume information (name, age, academic background, career, licenses, qualifications, desired employment conditions, etc.) of the job seeker himself/herself on the job information website. Next, the job seeker selects companies that match the desired conditions for the job seeker from among the recruiting companies registered on the job information website, and submits an entry to apply for employment. On the other hand, a recruiting company first registers job information (company information, job category, employment conditions including working conditions and benefits, etc.) on the job information website. Next, the recruiting company selects job seekers who match the human resource type required by the company from among the job seekers who submitted an entry to apply for employment with the company. After that, the recruiting company conducts employment tests, such as paper tests and interview tests, with the job seekers, and determines whether or not to hire the job seekers. Some attempts to promote matching between job seekers and recruiting companies have been proposed.

For example, Non-Patent Literature 1 (“Features of Recruitment Service and Recruitment Process”, [online], Recruit Career Co., Ltd., [retrieved on Feb. 28, 2014], retrieved from the Internet http://www.recruitcareer.co.jp/business/flow_agency/) discloses outplacement services in which a carrier adviser, or a special person in charge, conducts interviews with each job seeker and introduces a recruiting company, which is most suitable for the job seeker, to the job seeker.

Non-Patent Literature 2 (“Request and Application for Entry in Rikunabi”, [online], Recruit Career Co., Ltd., [retrieved on Feb. 28, 2014], retrieved from the Internet http://www.recruitcareer.co.jp/business/new_graduates/rikunabi/) discloses a function for recommending companies to job seekers by estimating the companies, which the job seekers are likely to be interested in in the future, based on the action history of each job seeker on a job information website by using a technique called collaborative filtering.

Collaborative filtering (CF) is a technique for use in predicting the preferences of each system user in a recommender system (see “Algorithms of Recommender Systems”, Toshihiro Kamishima, [online], [retrieved on Feb. 28, 2014], retrieved from the Internet <http://www.kamishima.net/archive/2007-s-jsai_rsys.pdf>). Collaborative filtering is used to specify other users having a high correlation with the preference data on the user, and the preferences of the other users are recommended to the user. In this regard, it can be said that collaborative filtering is a user-based recommender system.

As another method for implementing the recommender system, there is content-based filtering (CBF) for recommending items similar to the content (such as a retrieved sentence) preferred by each system user (see the specification of U.S. Pat. No. 4,839,853). A typical implementation example of content-based filtering is latent semantic indexing (LSI).

Latent semantic indexing is a technique for calculating the similarity between two input data items by calculating the cosine similarity between two vectors belonging to the same concept space, after conversion (feature extraction) of the vectors of the two input data items, which belong to a high-dimensional feature vector space, into a low-dimensional concept space (see the specification of U.S. Pat. No. 8,341,095). In this case, a transformation matrix from a feature vector space to a concept space is determined by singular value decomposition (unsupervised learning) for target data of the recommender system. Examples of latent semantic indexing include an algorithm applied to a search engine. The technique is characterized in that if a retrieved sentence and a retrieved document can be expressed in the same vector space, matching can be performed with a simple algorithm.

However, the type of preference data that can be treated by collaborative filtering is structured numeric data (for example, data in a matrix form in which the vertical axis represents a user ID and the horizontal axis represents a product ID). On the other hand, for example, resume information about job seekers and job information about recruiting companies, which are treated on job information websites, are semi-structured data including structured numeric data (SPI score, TOEIC score, etc.) and non-structured text data (academic background, career, job category, etc.). It is difficult for the collaborative filtering technique to treat such semi-structured data.

Unlike collaborative filtering, the latent semantic indexing technique can treat semi-structured data. However, it is necessary that two input data items to be matched can be expressed as vectors in the same feature vector space. In this regard, the resume information about job seekers and the job information about recruiting companies, which are treated on job information websites, for example, have different data structures and cannot be expressed as vectors in the same feature vector space. It is difficult for the latent semantic indexing technique to perform matching between two pieces of information that cannot be expressed as vectors in the same feature vector space.

The present invention has been made to solve the above-mentioned problems, and an object of the present invention is to provide a matching device, a matching method, and a non-transitory computer readable medium storing a program, which are capable of performing matching between two pieces of information having different properties.

Other objects and novel features of the invention will become apparent from the following description and the accompanying drawings.

### SUMMARY

A first exemplary aspect of the present invention is a matching device that performs matching between a human resource that searches for an organization that meets a specific requirement and an organization that searches for a human resource that meets a specific requirement, the matching device including: a storage unit that holds human resource information indicative of a requirement for the human resource and organization information indicative of a requirement for the organization; and a matching processing unit that calculates a matching score representing a relationship between the human resource information and the organization information.

A second exemplary aspect of the present invention is a matching method that performs matching between a human resource that searches for an organization that meets a specific requirement and an organization that searches for a human resource that meets a specific requirement, the matching method including a matching processing step of calculating a matching score representing a relationship between human resource information indicative of a requirement for the human resource and organization information representing a requirement for the organization.

A third exemplary aspect of the present invention is a non-transitory computer readable medium storing a program for causing a computer to execute the above-mentioned matching method.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1A is a diagram showing a configuration of a matching device 100 according to an exemplary embodiment of the present invention;

FIG. 1B is a diagram showing another configuration of the matching device 100 according to an exemplary embodiment of the present invention;

FIG. 1C is a diagram showing still another configuration of the matching device 100 according to an exemplary embodiment of the present invention;

FIG. 2 is a table showing an example of a job seeker information storage unit 1 according to an exemplary embodiment of the present invention;

FIG. 3 is a table showing an example of a recruiting company information storage unit 2 according to an exemplary embodiment of the present invention;

FIG. 4 is a table showing an example of an instruction signal storage unit 8 according to an exemplary embodiment of the present invention;

FIG. 5 is a table showing an example of a learning result storage unit 9 according to an exemplary embodiment of the present invention;

FIG. 6 is a flowchart showing an operation of a prior learning step of the matching device 100 according to an exemplary embodiment of the present invention;

FIG. 7 is a flowchart showing an operation of a matching step of the matching device 100 according to an exemplary embodiment of the present invention;

FIG. 8 is a diagram showing a configuration example of a matching display unit 12 according to an exemplary embodiment of the present invention;

FIG. 9 is a table showing an output example of the matching display unit 12 according to an exemplary embodiment of the present invention;

FIG. 10 is a diagram showing a configuration example of the matching display unit 12 according to an exemplary embodiment of the present invention;

FIG. 11 is a table showing an output example of the matching display unit 12 according to an exemplary embodiment of the present invention;

FIG. 12 is a diagram showing a configuration example of the matching display unit 12 according to an exemplary embodiment of the present invention;

FIG. 13 is a table showing an output example of the matching display unit 12 according to an exemplary embodiment of the present invention; and

FIG. 14 is a table showing an output example of the matching display unit 12 according to an exemplary embodiment of the present invention.

### EXEMPLARY EMBODIMENTS

Specific exemplary embodiments of the present invention will be described in detail below with reference to the accompanying drawings. A matching device 100 is a device that performs matching between a first object and a second object.

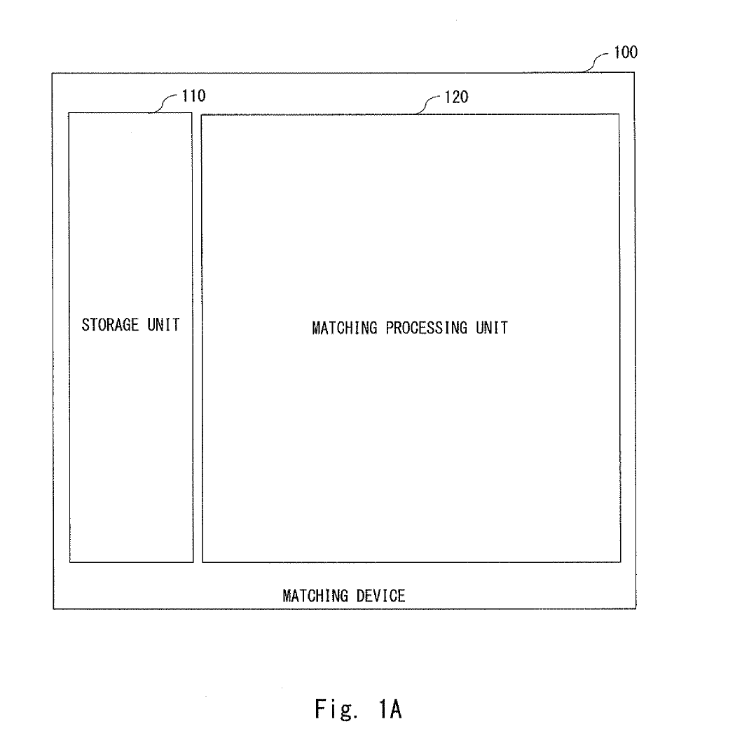

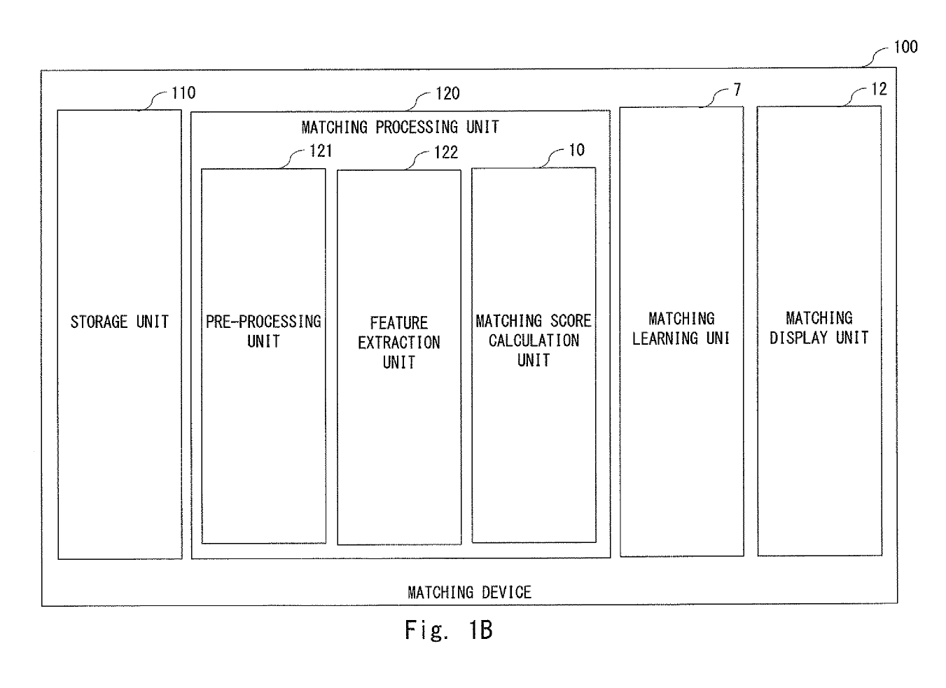

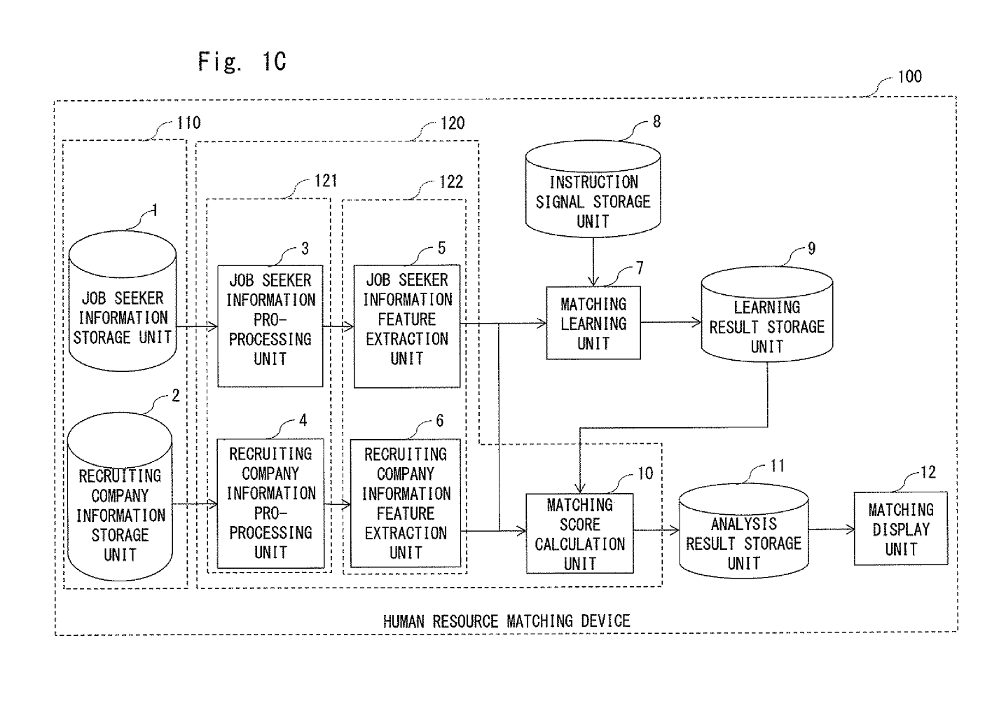

FIG. 1A shows the basic configuration of the matching device 100 according to an exemplary embodiment of the present invention. The matching device 100 basically includes a storage unit 110 and a matching processing unit 120. Typically, the matching device 100 is an information processor including a processor and a storage device capable of storing a program and the like. The storage unit 110 and the matching processing unit 120 are a logical storage unit and a logical processing unit, respectively, which are implemented by causing the processor to execute operation according to a program.

The storage unit 110 holds first information and second information. The first information includes a requirement for characterizing the first object, and the second information includes a requirement for characterizing the second object. For example, when the matching device 100 is a device that performs matching between a human resource that searches for an organization that meets a specific requirement and an organization that searches for a human resource that meets a specific requirement, the storage unit 110 holds human resource information and organization information. The human resource information indicates requirements for the human resource, and the organization information indicates requirements for the organization.

The matching processing unit 120 performs processing for calculating a matching score representing the relationship between the first information and the second information. When the matching device 100 is a device that performs matching between a human resource that searches for an organization that meets a specific requirement and an organization that searches for a human resource that meets a specific requirement, the matching processing unit 120 calculates a matching score representing the relationship between the human resource information and the organization information.

FIG. 1B shows another preferable configuration of the matching device 100. In this configuration, the matching device 100 further includes a matching learning unit 7 and a matching display unit 12. The matching processing unit 120 includes a pre-processing unit 121, a feature extraction unit 122, and a matching score calculation unit 10.

The pre-processing unit 121 performs processing for generating a first vector and a second vector based on the first information and the second information. For example, the pre-processing unit 121 generates a human resource vector and an organization vector based on the human resource information and the organization information, respectively.

The feature extraction unit 122 performs processing for extracting the features of the first vector and the second vector and converting the extracted features into a first feature vector and a second feature vector, respectively, which are vectors of the same dimension. For example, the feature extraction unit 122 extracts the features of the human resource vector and the organization vector and converts the extracted features into a human resource feature vector and an organization feature vector, respectively. The human resource feature vector and the organization vector are vectors of the same dimension.

The matching score calculation unit 10 performs processing for calculating, as the matching score, the similarity between the first feature vector and the second feature vector. For example, the matching score calculation unit 10 calculates, as the matching score, the similarity between the human resource feature vector and the organization feature vector.

The matching learning unit 7 receives an instruction signal representing the relationship between the first object and the second object, and performs processing for optimizing the feature extraction unit 122 based on the difference between the similarity and the instruction signal. For example, the matching learning unit 7 receives an instruction signal representing the relationship between the human resource and the organization, and optimizes the feature extraction unit 122 based on the difference between the similarity and the instruction signal.

The matching display unit 12 performs processing for displaying the matching results in various forms.

FIG. 1C shows a preferred implementation example in which the matching device 100 is applied to a job information website for matching between a human resource that searches for an organization that meets a specific requirement and an organization that searches for a human resource that meets a specific requirement. The configuration of the matching device 100 will be described in more detail below by taking the configuration shown in FIG. 1C as an example.

The matching device 100 includes a job seeker information storage unit 1, a recruiting company information storage unit 2, a job seeker information pre-processing unit 3, a recruiting company information pre-processing unit 4, a job seeker information feature extraction unit 5, a recruiting company information feature extraction unit 6, a matching learning unit 7, an instruction signal storage unit 8, a learning result storage unit 9, a matching score calculation unit 10, an analysis result storage unit 11, and a matching display unit 12. The job seeker information storage unit 1 and the recruiting company information storage unit 2 correspond to the storage unit 110. The job seeker information pre-processing unit 3 and the recruiting company information pre-processing unit 4 correspond to the pre-processing unit 121. The job seeker information feature extraction unit 5 and the recruiting company information feature extraction unit 6 correspond to the feature extraction unit 122.

The most typical example of the matching device 100 is a PC (personal computer). Alternatively, various devices such as a server may be used as the matching device 100. This exemplary embodiment assumes that the matching device 100 is a server. The functions and hardware configuration of a server are generally well-known, and thus the description thereof is omitted.

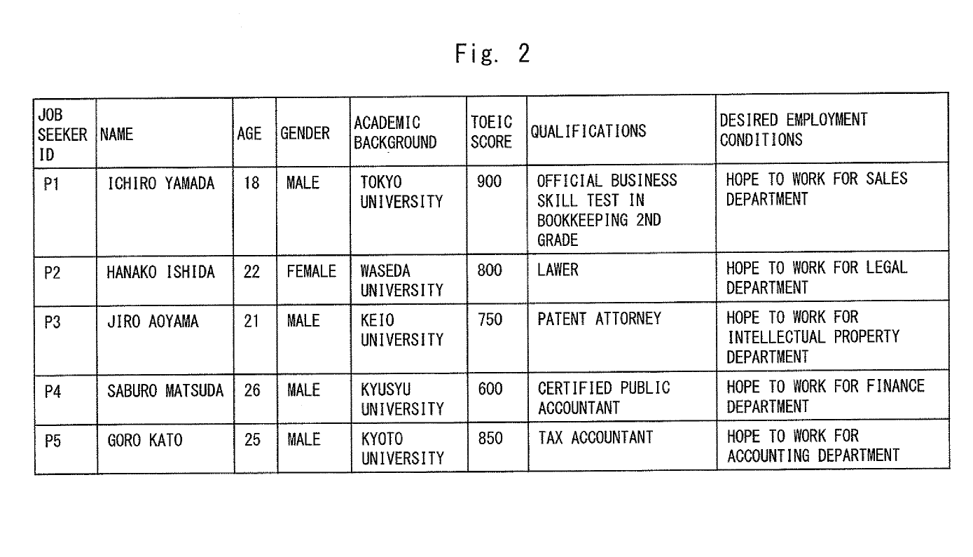

FIG. 2 shows examples of job seeker information held in the job seeker information storage unit 1. The job seeker information includes, for example, resume information, SNS information, and action history information, which are linked to the corresponding job seeker. The resume information includes information such as name, age, gender, academic background, career, TOEIC score, licenses, qualifications, and desired employment conditions, which are registered by each job seeker. The SNS information includes text messages posted on the SNS (social networking service), such as Facebook, Twitter, and blogs, by each job seeker. The action history information includes, for example, log information on the click operation performed by the job seeker on the job information website, and web page browsing records. The SNS information and the action history information about each job seeker can be obtained by various known methods, and thus the description thereof is omitted.

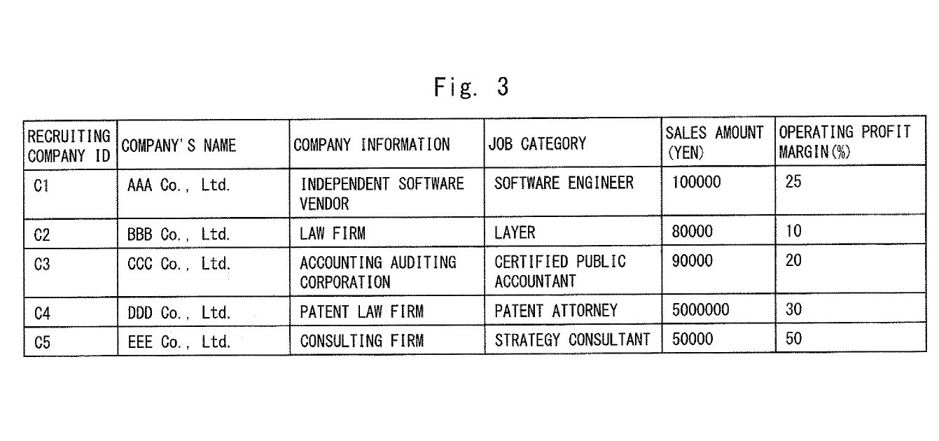

FIG. 3 shows examples of the recruiting company information held in the recruiting company information storage unit 2. The recruiting company information includes, for example, job information, SNS information, and research company information, which are linked to the corresponding recruiting company. The job information includes information such as company information, job category, and employment conditions, which are registered by each recruiting company. The public information includes, for example, product information, catalog information, and press release information. The SNS information includes text messages posted on the SNS, such as Facebook, Twitter, and blogs, by each recruiting company. The research company information includes, for example, quarterly journal information and credit information. The SNS information can be obtained by various known methods. The public information and the research company information are gathered by a known method, for example, from the web pages of the company and the research company. Alternatively, information provided by a given data source may be registered.

The job seeker information pre-processing unit 3 reads one record (data corresponding to one piece of job seeker information) from the job seeker information storage unit 1 according to an instruction from the matching learning unit 7 or the matching score calculation unit 10, and generates a job seeker vector by using the record information.

The recruiting company information pre-processing unit 4 reads one record (data corresponding to one piece of recording company information) from the recruiting company information storage unit 2 according to an instruction from the matching learning unit 7 or the matching score calculation unit 10, and generates a recruiting company vector by using the record information.

The job seeker vector and the recruiting company vector may be vectors of different dimensions.

The job seeker information feature extraction unit 5 extracts features from the job seeker vector, which is generated by the job seeker information pre-processing unit 3, thereby generating a job seeker feature vector.

The recruiting company information feature extraction unit 6 extracts features from the recruiting company vector, which is generated by the recruiting company information pre-processing unit 4, thereby generating a recruiting company feature vector.

This exemplary embodiment assumes that the job seeker information feature extraction unit 5 and the recruiting company information feature extraction unit 6 are each implemented using a hierarchical neural network (hereinafter referred to as “NN”). Specifically, the job seeker information feature extraction unit 5 and the recruiting company information feature extraction unit 6 extract features from the job seeker vector and the recruiting company vector, respectively, by using a known hierarchical NN, to thereby generate the job seeker feature vector and the recruiting company vector, respectively.

The matching learning unit 7 performs machine learning of the relationship between the job seekers and the recruiting companies based on the job seeker feature vector generated by the job seeker information feature extraction unit 5, the recruiting company feature vector generated by the recruiting company feature extraction unit 6, and the instruction signal read from the instruction signal storage unit 8.

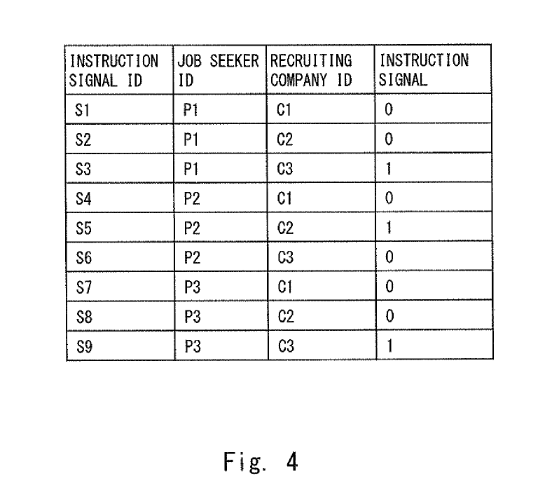

FIG. 4 shows examples of the instruction signal which is held in the instruction signal storage unit 8 and represents the relationship between the job seekers and the recruiting companies. In this example, the instruction signal indicating “0” or “1” is defined for a combination of a job seeker and a recruiting company. The instruction signal can be defined based on, for example, pass/fail results indicating whether or not the recruiting companies hire the job seekers (pass=1, fail=0), job seekers' preferences for the recruiting companies (like=1, dislike=0), or job seekers' performances (excellent=1, poor=0) after joining the recruiting companies. The instruction signal is not necessarily be a binary signal, but may be a multi-valued signal or a continuous-valued signal.

The learning result storage unit 9 holds the learning result of the matching learning unit 7.

The matching score calculation unit 10 calculates a matching score between the job seeker and the recruiting company based on the job seeker feature vector generated by the job seeker information feature extraction unit 5 and the recruiting feature vector generated by the recruiting company feature extraction unit 6.

This exemplary embodiment assumes that the calculation of the similarity between the job seeker feature vector and the recruiting company feature vector in each of the matching learning unit 7 and the matching score calculation unit 10 is implemented using a cosine similarity. Specifically, the matching learning unit 7 and the matching score calculation unit 10 calculate the cosine similarity between the job seeker feature vector and the recruiting company feature vector, and output the calculation result as the matching score.

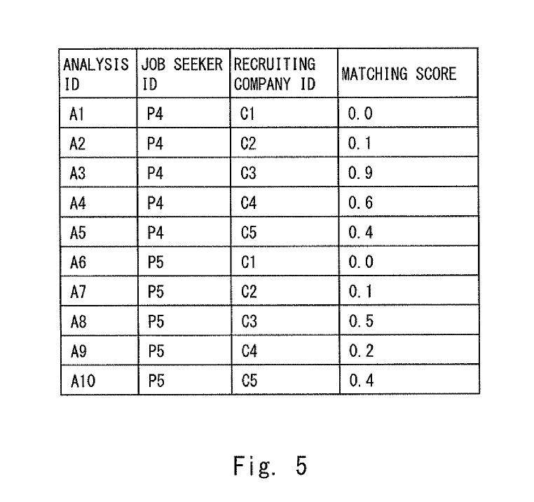

The analysis result storage unit 11 holds each matching score between a job seeker and a recruiting company, which is calculated by the matching score calculation unit 10. FIG. 5 shows examples of the matching score stored in the analysis result storage unit 11. In this example, the matching score represented as a value between 0 to 1 is held for a combination of a job seeker and a recruiting company.

The matching display unit 12 reads each matching score between a job seeker and a recruiting company from the analysis result storage unit 11, and displays the read matching score.

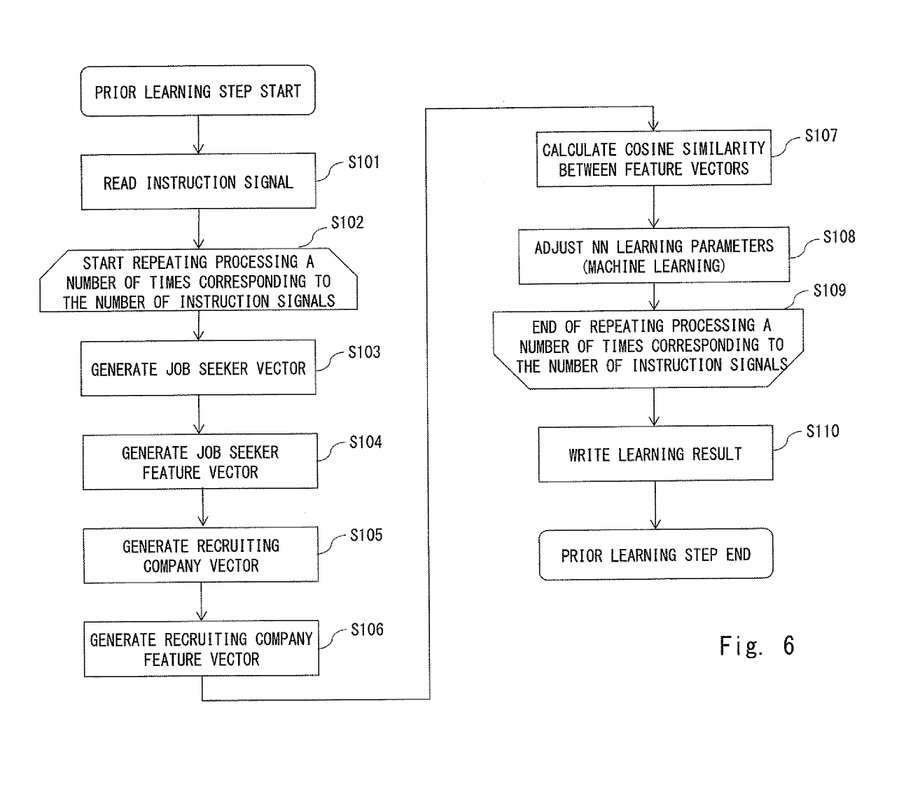

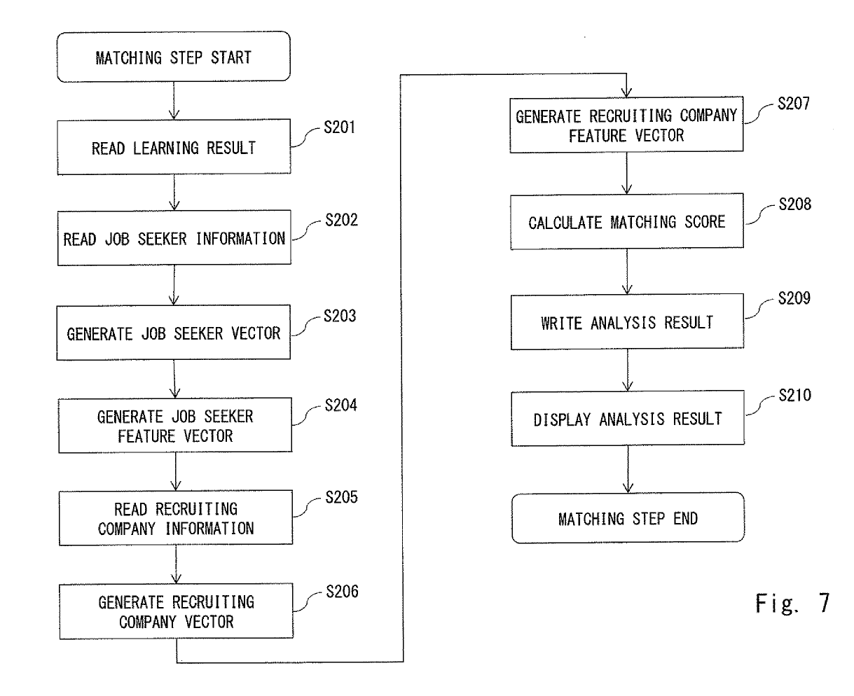

Next, the operation of the matching device 100 will be described with reference to the flowcharts of FIGS. 6 and 7. The operation of the matching device 100 is roughly divided into two steps, i.e., a prior learning step and a matching step.

In the prior learning step, the matching learning unit 7 performs machine learning based on the instruction signal which is held in the instruction signal storage unit 8 in such a manner that the instruction signal is linked to the corresponding job seeker and the corresponding recruiting company, that is, based on the information indicating the relationship between the job seeker and the recruiting company. Further, the matching learning unit 7 adjusts learning parameters (weights) of the NN of each of the job seeker information feature extraction unit 5 and the recruiting company information feature extraction unit 6, and writes the learning result into the learning result storage unit 9.

In the matching step, the matching score calculation unit 10 reads the learning result of the prior learning step from the learning result storage unit 9, sets the learning parameters (weights) of the MN of each of the job seeker information feature extraction unit 5 and the recruiting company information feature extraction unit 6, calculates an unknown matching score between the job seeker information and the recruiting company information, and writes the calculation result into the analysis result storage unit 11. The matching display unit 12 presents to a user the analysis result written in the analysis result storage unit 11.

(Prior Learning Step)

FIG. 6 is a flowchart showing the operation of the prior learning step of the matching device 100.

S101: Read the Instruction Signal

The matching learning unit 7 reads, from the instruction signal storage unit 8, a list including at least one record including <job seeker ID, recruiting company ID, instruction signal>. This exemplary embodiment assumes that the instruction signal is a binary signal having a value “1” which indicates that there is a relationship between the job seeker and the recruiting company, and a value “0” which indicates that there is no relationship between the job seeker and the recruiting company. The instruction signal can be defined based on, for example, pass/fail results indicating whether or not the recruiting companies hire the job seekers (pass=1, fail=0), job seekers' preferences for the recruiting companies (like=1, dislike=0), or job seekers' performances (excellent=1, poor=0) after joining the recruiting companies.

The instruction signal may be a multi-valued signal (for example, an integer value within a predetermined range, such as 0 to 100) depending on the relationship between the job seeker and the recruiting company. For example, the number of reactions (the number of times of pressing “Like” button) by the job seeker on the SNS (Facebook page etc.) of the recruiting company, the number of tweets on Twitter regarding the recruiting company, or the number of postings on Internet forums can be used as the value of the instruction signal.

Alternatively, the instruction signal may be a continuous-value signal (for example, a real number in a range from 0 to 1) depending on the relationship between the job seeker and the recruiting company. For example, the number of tweets by the job seeker on Twitter regarding the recruiting company is divided by the total number of tweets on Twitter regarding the recruiting company, and the calculation result is normalized between 0 and 1. The value thus obtained can be used as the value of the instruction signal.

S102: Start Repeating Processing a Number of Times Corresponding to the Number of Instruction Signals

The matching learning unit 7 repeats the subsequent processing of S103 to S108 a number of times corresponding to the number of records included in the list read in S101.

S103: Generate the Job Seeker Vector

The matching learning unit 7 drives the job seeker information pre-processing unit 3 and instructs the job seeker information pre-processing unit 3 to read the job seeker information corresponding to the job seeker ID obtained in S101. The job seeker information pre-processing unit 3 obtains the job seeker information corresponding to the job seeker ID with reference to the job seeker information storage unit 1, and performs pre-processing of the job seeker information to convert the information into a vector form, thereby generating the job seeker vector. The method for generating vectors from information is known, and thus the detailed description thereof is omitted.

S104: Generate the Job Seeker Feature Vector

The matching learning unit 7 drives the job seeker information feature extraction unit 5 and instructs the job seeker information feature extraction unit 5 to read the job seeker vector generated in S103. The job seeker information feature extraction unit 5 extracts features from the read job seeker vector by using the NN, thereby generating the job seeker feature vector.

Depending on the network structure (the number of hidden layers, connection mode between nodes, and activation function, etc.), various neural networks (such as a three-layer neural network, an RBF network, and a multi-layer neural network) can be used as the NN for the job seeker information feature extraction unit 5. Any of these techniques can be applied in this exemplary embodiment. The method for vector feature extraction using the NN is known, and thus the detailed description thereof is omitted.

S105: Generate the Recruiting Company Vector

The matching learning unit 7 drives the recruiting company information pre-processing unit 4 and instructs the recruiting company information pre-processing unit 4 to read the recruiting company information corresponding to the recruiting company ID obtained in S101. The recruiting company information pre-processing unit 4 performs pre-processing of the recruiting company information to convert the information into a vector form, thereby generating the recruiting company vector. The method for generating vectors from information is known, and thus the detailed description thereof is omitted.

S106: Generate the Recruiting Company Feature Vector

The matching learning unit 7 drives the recruiting company information feature extraction unit 6 and instructs the recruiting company information feature extraction unit 6 to read the recruiting company vector generated in S105. The recruiting company information feature extraction unit 6 extracts features from the recruiting company vector by using the NN, thereby generating the recruiting company feature vector.

Depending on the network structure (the number of hidden layers, connection mode between nodes, and activation function, etc.), various neural networks (such as a three-layer neural network, an RBF network, and a multi-layer neural network) can be used as the NN for the recruiting company information feature extraction unit 6. Any of these techniques can be applied in this exemplary embodiment. The method for vector feature extraction using the NN is known, and thus the detailed description thereof is omitted.

In this case, the job seeker feature vector and the recruiting company feature vector, which are generated by the processing of S104 and S106, respectively, are preferably generated using different NNs. Accordingly, even if the job seeker vector and the recruiting company vector are vectors of different dimensions, the feature vectors of the same dimension can be output.

Basically, the number of dimensions of the feature vectors generated using the NNs is arbitrarily determined. However, it is preferable that the number of dimensions of the feature vectors be smaller than the number of dimensions of each of the job seeker vector and the recruiting company vector. This is because it is considered that the input vectors, i.e., the job seeker vector and the recruiting company vector, include a fluctuation, noise, or meaningless information in many cases, and thus the feature vectors can be expressed by the amount of information (the number of dimensions) smaller than that of the input vectors. The number of dimensions of the feature vectors is preferably about several tens to several hundreds. This is because more calculation resources (the usage of a CPU, a memory, a disc, etc.) are needed as the number of dimensions of the feature vectors increases. According to the findings of the inventors, the number of dimensions in the above-mentioned range is appropriate for carrying out the present invention in a general-purpose server with a typical configuration at present.

S107: Calculate the Cosine Similarity Between the Feature Vectors

The matching learning unit 7 calculates the cosine similarity between the job seeker feature vector generated in S104 and the recruiting company feature vector generated in S106. The method for calculating the cosine similarity is known, and thus the detailed description thereof is omitted.

While the cosine similarity is used as an index for measuring the similarity between two vectors in this exemplary embodiment, any other indices (Pearson's correlation coefficient, deviation pattern similarity, etc.) may be used to indicate the similarity. These indices can be used to evaluate the similarity in such a manner that a larger value indicates a greater similarity. Alternatively, any indices (L1 norm, L2 norm, etc.) indicating the distance between two vectors may be used to evaluate the similarity. These indices can be used to evaluate the similarity in such a manner that a smaller value indicates a greater similarity.

S108: Adjust NN Learning Parameters (Machine Learning)

The matching learning unit 7 calculates the difference (estimation error) between the cosine similarity calculated in S107 and the instruction signal (having a value of “0” or “1”) obtained in S101, and adjusts the learning parameters (weight factors) of the NN of each of the job seeker information feature extraction unit 5 and the recruiting company information feature extraction unit 6 by error backpropagation using the calculated value. The error backpropagation is known, and thus the detailed description thereof is omitted.

While the error backpropagation is used as the method for adjusting the learning parameters of the NN in this exemplary embodiment, any other machine learning methods (such as a steepest descent method, a stochastic gradient descent method, and Greedy Layer-Wise Training) can be used to adjust the learning parameters of the NN.

S109: Repeat Processing a Number of Times Corresponding to the Number of Instruction Signals

The matching learning unit 7 repeats the above-mentioned processing of S103 to S108 a number of times corresponding to the number of lists read in S101.

S110: Write the Learning Result

The matching learning unit 7 writes, into the learning result storage unit 9, the learning parameters (weights) of the NN of each of the job seeker information feature extraction unit 5 and the recruiting company information feature extraction unit 6.

(Matching Step)

FIG. 7 is a flowchart showing the operation of the matching step of the matching device 100.

S201: Read the Learning Result

The matching score calculation unit 10 reads, from the learning result storage unit 9, the learning parameters (weights) of the NN of each of the job seeker information feature extraction unit 5 and the recruiting company information feature extraction unit 6.

S202: Read the Job Seeker Information

The matching score calculation unit 10 drives the job seeker information pre-processing unit 3 and instructs the job seeker information pre-processing unit 3 to read the job seeker information for which the matching score is calculated. The job seeker information pre-processing unit 3 obtains the job seeker information, for which the matching score is calculated, through any input means or storage means.

S203: Generate the Job Seeker Vector

The job seeker information pre-processing unit 3 performs pre-processing of the job seeker information read in S202, and converts the information into a vector form, thereby generating the job seeker vector.

S204: Generate the Job Seeker Feature Vector

The matching score calculation unit 10 drives the job seeker information feature extraction unit 5 and instructs the job seeker information feature extraction unit 5 to read the job seeker vector generated in S203. The job seeker information feature extraction unit 5 reads the job seeker vector and extracts features from the job seeker vector by using the NN, thereby generating the job seeker feature vector.

S205: Read the Recruiting Company Information

The matching score calculation unit 10 drives the recruiting company information pre-processing unit 4 and instructs the recruiting company information pre-processing unit 4 to read the recruiting company information for which the matching score is calculated. The recruiting company information pre-processing unit 4 obtains the recruiting company information, for which the matching score is calculated, through any input means or storage means.

S206: Generate the Recruiting Company Vector

The recruiting company information pre-processing unit 4 performs pre-processing of the recruiting company information read in S205, and converts the information into a vector form, thereby generating the recruiting company vector.

S207: Generate the Recruiting Company Feature Vector

The matching score calculation unit 10 drives the recruiting company information feature extraction unit 6 and instructs the recruiting company information feature extraction unit 6 to read the recruiting company vector generated in S206. The recruiting company information feature extraction unit 6 reads the recruiting company vector and extracts features from the recruiting company vector by using the NN, thereby generating the recruiting company feature vector.

In this case, the job seeker feature vector and the recruiting company feature vector, which are generated by the processing of S204 and S207, respectively, are vectors of the same dimension, as with the feature vectors generated in the prior learning step.

S208: Calculate the Matching Score

The matching score calculation unit 10 calculates the cosine similarity between the job seeker feature vector generated in S204 and the recruiting company feature vector generated in S207, and uses this value as the matching score between the job seeker and the recruiting company. As a result, the matching score between one job seeker and one recruiting company can be calculated. In this case, a matching score close to 1 indicates that the job seeker and the recruiting company are compatible, and a matching score close to 0 indicates that the job seeker and the recruiting company are incompatible.

While the value of the cosine similarity is directly used as the matching score in this exemplary embodiment, the matching score may be any value that can be calculated based on the cosine similarity. While the cosine similarity between two vectors is used as the index for calculating the matching score in this exemplary embodiment, any other indices (Pearson's correlation coefficient, deviation pattern similarity, etc.) may be used to indicate the similarity. These indices can be used to evaluate the similarity in such a manner that a larger value indicates a greater similarity. Alternatively, any indices (L1 norm, L2 norm, etc.) indicating the distance between two vectors may be used to calculate the matching score. These indices can be used to evaluate the matching score in such a manner that a smaller value indicates a greater compatibility.

The matching score calculation unit 10 can also calculate a matching score between one job seeker and a plurality of recruiting companies. A method for calculating a matching score between a job seeker and a recruiting company group will be described below.

For example, the matching score calculation unit 10 can sequentially calculate, in a round-robin fashion, matching scores between a job seeker and recruiting companies constituting a recruiting company group, and can use the summation or average of the calculated matching scores as the matching score between the recruiting company group and the job seeker. Specifically, assuming that the recruiting companies constituting the recruiting company group are represented as {C1, C2, . . . , CN} (N represents the number of recruiting companies); the job seeker is represented as {P1}; the matching scores between the recruiting companies constituting the recruiting company group and the job seeker are represented as {S1, S2, . . . , SN}; the matching score between the recruiting company group and the job seeker is represented as {SP1}; and the enumeration function of the matching score between each recruiting company and the job seeker is represented as a score (C, P), the matching score calculation unit 10 executes the following processing flow.

(1) The matching scores {S1, S2, . . . , SN} between the recruiting companies {C1, C2, . . . , CN}, which constitute the recruiting company group, and the job seeker {P1} are calculated in a round-robin fashion.

S1=score(C1,P1)

S2=score(C2,P1)

. . .

SN=score(CN,P1)

(2) The summation or average of the matching scores {S1, S2, . . . , SN} calculated in the above processing (1) is calculated.

(Summation) SP1=S1+S2+ . . . +SN

(Average) SP1=(S1+S2+ . . . +SN)/N
(3) The matching score {SP1} is returned as the matching score between the recruiting company group {C1, C2, . . . , CN} and the job seeker {P1}.

Further, the matching score calculation unit 10 can also calculate a matching score between one recruiting company and a plurality of job seekers. The matching score between a recruiting company and a job seeker group can be obtained by an application of the method for calculating the matching score between the job seeker and the recruiting company group as described above. Specifically, assuming that the job seekers constituting the job seeker group are represented as {P1, P2, . . . , PN} (N represents the number of job seekers); the recruiting company is represented as {C1}; the matching scores between the job seekers constituting the job seeker group and the recruiting company are represented as {S1, S2, . . . , SN}; the matching score between the job seeker group and the recruiting company is represented as {SC1}; and the enumeration function of the matching score between the recruiting company and each job seeker is represented as a score (C, P), the matching score calculation unit 10 executes the following processing flow.
(1) The matching scores {S1, S2, . . . , SN} between the job seekers {P1, P2, . . . , PN}, which constitute the job seeker group, and the recruiting company {C1} are calculated in a round-robin fashion.

S1=score(C1,P1)

S2=score(C2,P1)

SN=score(CN,P1)

(2) The summation or average of the matching scores {S1, S2, . . . , SN} calculated in the above processing (1) is calculated.

(Summation) SC1=S1+S2+ . . . +SN

(Average) SC1=(S1+S2+ . . . +SN)/N

(3) The matching score {SC1} is returned as the matching score between the job seeker group {P1, P2, . . . , PN} and the recruiting company {C1}.

S209: Write the Analysis Result

The matching score calculation unit 10 writes, into the analysis result storage unit 11, an information set <job seeker ID, recruiting company ID, matching score> including the matching score calculated in S208.

S210: Display the Analysis Result

The matching display unit 12 obtains the list of <job seeker ID, recruiting company ID, matching score> from the analysis result storage unit 11, and presents the obtained list to the user.

Examples of the method for presenting the obtained list to the user include the following methods.

(1) To present a list of job seekers with highest matching scores to a recruiting company

The matching score calculation unit 10 calculates, in a round-robin fashion, matching scores between a specific recruiting company and all job seekers. The matching display unit 12 creates a job seeker list including top N job seekers with highest matching scores, and presents the job seeker list to the recruiting company.

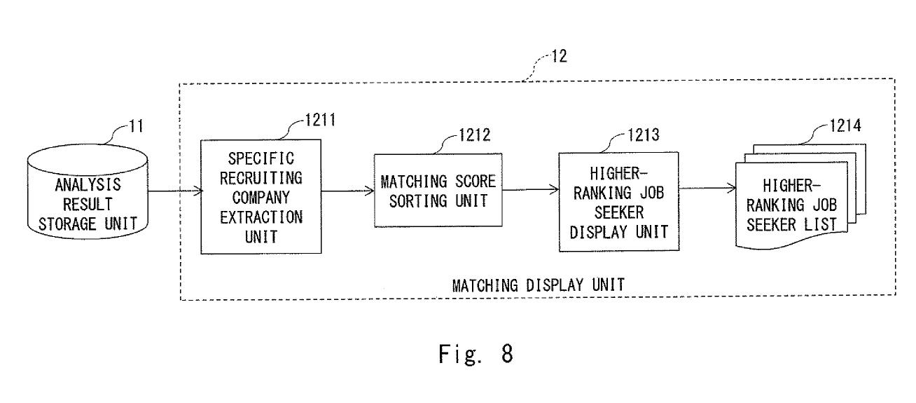

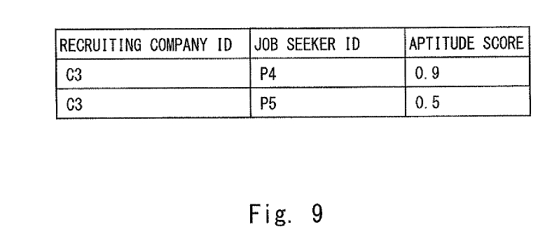

FIG. 8 is a block diagram showing the matching display unit 12 that implements the above-mentioned presenting method (1). FIG. 9 shows a display example of a higher-ranking job seeker list 1214.

Referring to FIG. 8, a specific recruiting company extraction unit 1211 extracts, from the analysis result storage unit 11, all records matching a specific recruiting company. A matching score sorting unit 1212 sorts the extraction results of the specific recruiting company extraction unit 1211 in a descending order of the matching scores. A higher-ranking job seeker display unit 1213 displays, in the higher-ranking job seeker list 1214 (FIG. 9), top N job seekers selected based on the sorting result of the specific recruiting company extraction unit 1211.

While the list of job seekers with highest matching scores is displayed in the presenting method, a list of job seekers with lowest matching scores may be displayed for the purpose of, for example, reducing the number of job seekers by eliminating those who are less likely to be hired.

(2) To present a list of recruiting companies with highest matching scores to a job seeker

The matching score calculation unit 10 calculates, in a round-robin fashion, matching scores between a specific job seeker and all recruiting companies. The matching display unit 12 creates a recruiting company list including top N recruiting companies with highest matching scores, and presents the recruiting company list to the job seeker.

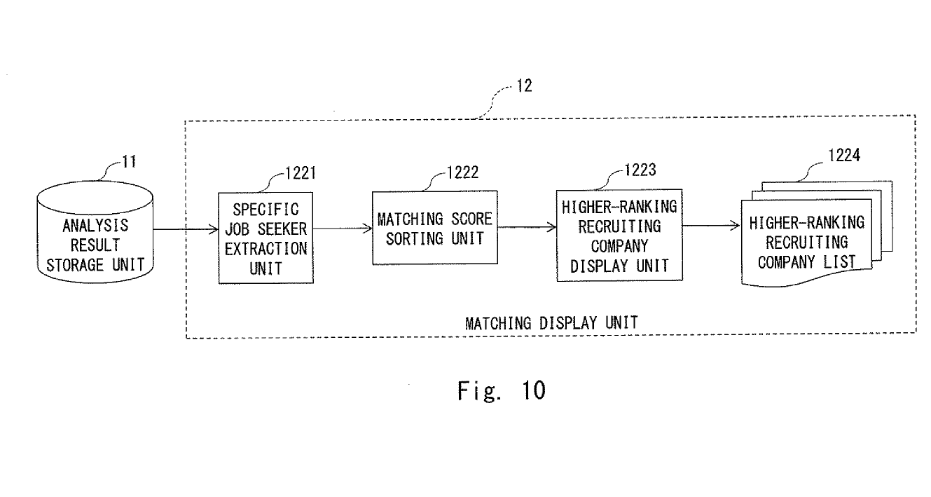

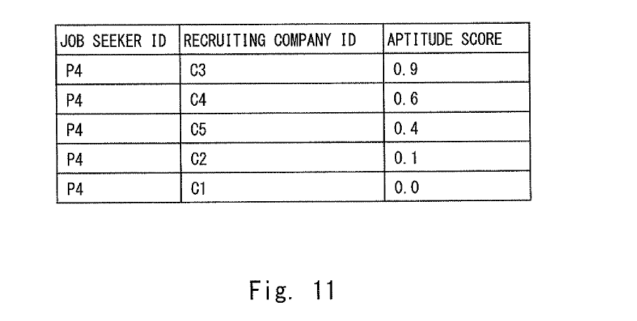

FIG. 10 is a block diagram showing the matching display unit 12 that implements the above-mentioned present method (2). FIG. 11 shows a display example of a higher-ranking recruiting company list 1224.

Referring to FIG. 10, a specific job seeker extraction unit 1221 extracts, from the analysis result storage unit 11, all records matching a specific job seeker. A matching score sorting unit 1222 sorts the extraction results of the specific job seeker extraction unit 1221 in a descending order of the matching scores. A higher-ranking recruiting company display unit 1223 displays, in the higher-ranking recruiting company list 1224 (FIG. 11), top N recruiting companies in the storing results of the specific job seeker extraction unit 1221.

While the list of recruiting companies with highest matching scores is displayed in the presenting method, a list of recruiting companies with lowest matching scores may be displayed for the purpose of, for example, reducing the number of job seekers by eliminating those who are less likely to be hired.

(3) To present a list of job seekers with highest matching scores to a specific recruiting company group

The matching score calculation unit 10 calculates, in a round-robin fashion, matching scores between a specific recruiting company group, which is selected under the conditions of, for example, the type of business, and all job seekers. In this case, the conditions for selecting recruiting companies are not limited to the type of business, and any conditions may be used. The matching display unit 12 creates a job seeker list including top N job seekers with highest summation of matching scores, and presents the job seeker list to the recruiting companies.

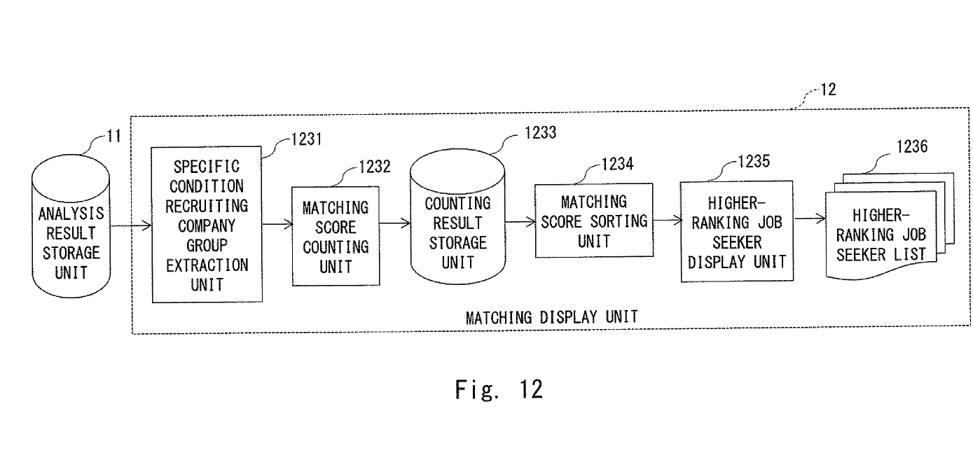

FIG. 12 is a block diagram showing the matching display unit 12 that implements the above-mentioned presenting method (3). FIG. 14 shows a display example of a higher-ranking job seeker list 1236.

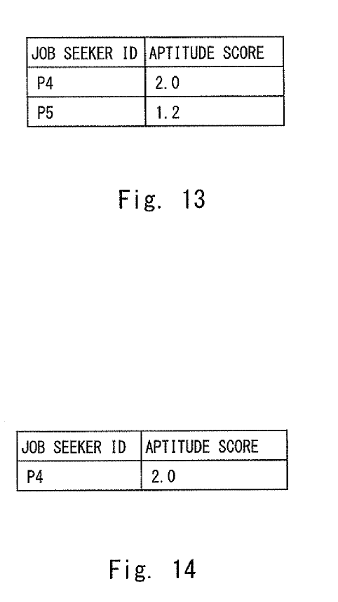

Referring to FIG. 12, a specific condition recruiting company extraction unit 1231 extracts, from the analysis result storage unit 11, all records matching the recruiting companies that satisfy specific conditions (such as the type of business, job category, and annual sales). A matching score counting unit 1232 calculates the summation (hereinafter referred to as “aptitude score”) of the matching scores of each job seeker for the extraction results of the specific condition recruiting company extraction unit 1231, and writes the counting results into a counting result storage unit 1233 (FIG. 13). A matching score sorting unit 1234 sorts the counting results stored in the counting result storage units 1233 in a descending order of the aptitude scores. A higher-ranking job seeker display unit 1235 displays, in the higher-ranking job seeker list 1236 (FIG. 14), top N job seekers selected based on the sorting result of the matching score sorting unit 1234.

While the list of job seekers with highest matching scores is displayed in the presenting method, a list of job seekers with lowest matching scores may be displayed for the purpose of, for example, reducing the number of job seekers by eliminating those who are less likely to be hired.

While the type of business and the like are used as a method to extract a specific recruiting company group in this presenting method, any recruiting company information such as location, credit information, finance information (capital, sales), and year and month of establishment may be used. Alternatively, each user may select a recruiting company group based on arbitrary conditions such as companies listed on the first section of the Tokyo Stock Exchange, or companies which are widely regarded as having produced a large number of excellent human resources.

In this exemplary embodiment, the matching device 100 calculates the matching score representing the relationship between the human resource information and the organization information. This makes it possible to carry out matching between job seekers and recruiting companies. In other words, recruiting companies that match the types of job seekers can be recommended to the job seekers, and job seekers that match the types of job seekers required by recruiting companies can be recommended to the recruiting companies.

In this exemplary embodiment, feature extraction is performed on two pieces of information to be matched by using different hierarchical neural networks (NNs). This makes it possible to convert the two pieces of information on the same feature vector space, though the two pieces of information conventionally cannot be expressed on the same feature vector space because the two pieces of information are semi-structured data including structured numeric data and non-structured text data and have different data structures.

### Other Exemplary Embodiments

The present invention is not limited to the above exemplary embodiments, and can be modified in various manners without departing from the scope of the invention. For example, a main object of the above exemplary embodiments is to perform matching between a job seeker and a recruiting company, which is targeted at new graduates or mid-career employment. However, the present invention can also be applied to a more general matching, such as matching between a person and an organization, by changing the data items held in the job seeker information storage unit 1 and the recruiting company information storage unit 2.

For example, in the case of resource shift (such as personnel reshuffle, open recruitment, or employment extension) in a company, matching between an employee and a department of the company can be used. In this case, examples of the employee information may include role definition, career review, performance review, medical examination report, relocation history, a length of service, and occupational ability information. Examples of the department information may include role definition, business performance, and opinion/survey results (evaluation of satisfaction of employees belonging to the department).

A main object of the above exemplary embodiments is to perform matching between a job seeker and a recruiting company, and more generally, matching between a person and an organization. However, the present invention is not limited to the above exemplary embodiments. The present invention can be applied to various types of matching between sets of information which can be converted into a vector form.

While the present invention has been mainly described as a hardware configuration in the exemplary embodiments described above, the present invention is not limited to this. Any processing can be implemented by causing a CPU (Central Processing Unit) to execute a computer program. In this case, the computer program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

According to the present invention, it is possible to provide a matching device, a matching method, and a non-transitory computer readable medium storing a program, which are capable of performing matching between two pieces of information having different properties.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A matching device that performs matching between a human resource that searches for an organization that meets a specific requirement and an organization that searches for a human resource that meets a specific requirement, the matching device comprising:
a storage unit that holds human resource information indicative of a requirement for the human resource and organization information indicative of a requirement for the organization; and
a matching processing unit that calculates a matching score representing a relationship between the human resource information and the organization information.

2. The matching device according to claim 1, wherein
the matching processing unit comprises:
a pre-processing unit that generates a human resource vector and an organization vector based on the human resource information and the organization information, respectively;
a feature extraction unit that extracts features of the human resource vector and the organization vector and converts the extracted features into a human resource feature vector and an organization feature vector, respectively, the human resource feature vector and the organization feature vector being vectors of the same dimension; and
a matching score calculation unit that calculates, as the matching score, a similarity between the human resource feature vector and the organization feature vector.

3. The matching device according to claim 2, wherein the feature extraction unit extracts features of the human resource vector and the organization vector by using different hierarchical neural networks, and converts the extracted features into the human resource feature vector and the organization feature vector, respectively, the human resource feature vector and the organization feature vector being vectors of the same dimension.

4. The matching device according to claim 3, further comprising a matching learning unit that receives an instruction signal representing a relationship between the human resource and the organization, and optimizes the feature extraction unit based on a difference between the similarity and the instruction signal.

5. The matching device according to claim 4, wherein the matching learning unit adjusts learning parameters of the neural networks by error backpropagation using the difference.

6. The matching device according to claim 2, wherein the human resource vector and the organization vector are vectors of different dimensions that cannot be expressed in the same feature vector space.

7. The matching device according to claim 1, wherein at least one of the human resource information and the organization information is semi-structured data including structured numeric data and non-structured text data.

8. The matching device according to claim 2, wherein the matching processing unit calculates a matching score by calculating one of a cosine similarity and a norm between the human resource feature vector and the organization feature vector.

9. The matching device according to claim 1, further comprising a matching display unit that displays a matching result, wherein
the matching processing unit calculates matching scores between a specific organization and a plurality of human resources, and
the matching display unit arranges and displays the plurality of human resources in an ascending order or a descending order of the matching scores.

10. The matching device according to claim 1, further comprising a matching display unit that displays a matching result, wherein
the matching processing unit calculates matching scores between a specific human resource and a plurality of organizations, and
the matching display unit arranges and displays the plurality of organizations in an ascending order or a descending order of the matching scores.

11. The matching device according to claim 1, further comprising a matching display unit that displays a matching result, wherein
the matching processing unit calculates matching scores between an organization group including a plurality of organizations and a plurality of human resources, and
the matching display unit arranges and displays the plurality of human resources in an ascending order or a descending order of the matching scores.

12. A matching method that performs matching between a human resource that searches for an organization that meets a specific requirement and an organization that searches for a human resource that meets a specific requirement, the matching method comprising:
a matching processing step of calculating a matching score representing a relationship between human resource information indicative of a requirement for the human resource and organization information representing a requirement for the organization.

13. The matching method according to claim 12, wherein
the matching processing step comprises:
a pre-processing step of generating a human resource vector and an organization vector based on the human resource information and the organization information, respectively;
a feature extraction step of extracting features of the human resource vector and the organization vector and converting the extracted features into a human resource feature vector and an organization feature vector, respectively, the human resource feature vector and the organization feature vector being vectors of the same dimension; and
a matching score calculation step of calculating, as the matching score, a similarity between the human resource feature vector and the organization feature vector.

14. The matching method according to claim 13, wherein the feature extraction step includes extracting features of the human resource vector and the organization vector by using different hierarchical neural networks, and converting the extracted features into the human resource feature vector and the organization feature vector, respectively, the human resource feature vector and the organization feature vector being vectors of the same dimension.

15. The matching method according to claim 14, further comprising a matching learning step of receiving an instruction signal representing a relationship between the human resource and the organization, and optimizing the feature extraction step based on a difference between the similarity and the instruction signal.

16. The matching method according to claim 15, wherein the matching learning step includes adjusting learning parameters of the neural networks by error backpropagation using the difference.

17. The matching method according to claim 13, wherein the human resource vector and the organization vector are vectors of different dimensions that cannot be expressed in the same feature vector space.

18. The matching method according to claim 12, wherein at least one of the human resource information and the organization information is semi-structured data including structured numeric data and non-structured text data.

19. The matching method according to claim 13, wherein the matching processing step includes calculating a matching score by calculating one of a cosine similarity and a norm between the human resource feature vector and the organization feature vector.

20. The matching method according to claim 12, further comprising a matching display step of calculating matching scores between a specific organization and a plurality of human resources, and arranging and displaying the plurality of human resources in an ascending order or a descending order of the matching scores.

21. The matching method according to claim 12, further comprising a matching display step of calculating matching scores between a specific human resource and a plurality of organizations, and arranging and displaying the plurality of organizations in an ascending order or a descending order of the matching scores.

22. The matching method according to claim 12, further comprising a matching display step of calculating matching scores between an organization group including a plurality of organizations and a plurality of human resources, and arranging and displaying the plurality of human resources in an ascending order or a descending order of the matching scores.

23. A non-transitory computer readable medium storing a program for causing a computer to execute the matching method according to claim 12.
